(19) United States
(12) Patent Application Publication
(10) Pub. No.: US 2009/0144207 A1
(43) Pub. Date: Jun. 4, 2009

(54) PROGRESSIVE PRICING SCHEMES FOR ADVERTISEMENTS

(75) Inventors: EWA DOMINOWSKA, KIRKLAND, WA (US); ROBERT J. RAGNO, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/949,548

(22) Filed: Dec. 3, 2007

(51) Int. Cl. G06F 17/00; G06Q 20/00

(52) U.S. Cl. 705/400

(57) ABSTRACT

Systems, methods, and computer-readable media for calculating charges for advertisements are provided. The historical performance (such as CTR) of an online advertisement is utilized to calculate accurate performance prediction, in turn used to calculate the current cost per selection (click-through) of the advertisement. The current cost per selection may be multiplied by the total number of times the advertisement has been presented to user(s) to determine the adjusted revenue total for the advertisement. In embodiments, the charge due for the advertisement is the adjusted revenue total for the advertisement less the amount of revenue previously received for the advertisement.

### BACKGROUND

Online advertising has become a significant aspect of the Web browsing experience. Today, many search engines generate revenue through advertisements positioned adjacent to a user's search query results. For example, many search engine providers, such as Microsoft, Google and Yahoo, receive payment from advertisers based upon pay-per-performance models, e.g. cost-per-click and cost-per-action\conversion models.

When estimating expected advertisement performance, a number of historical advertisement performance measures are typically utilized. For instance, in a cost-per-click model, click-through rates (CTRs) may be utilized to estimate the expected future performance of advertisements. Thus, if an advertisement is displayed 100 times and is selected five times by a user, the historical CTR of the advertisement is 0.05. Accordingly, the estimated future advertisement performance is also 0.05 with a confidence rate of 100 impressions. As the system observes more impressions the estimate is adjusted and the confidence increases.

In some cases, sufficient historical advertisement performance measures may not exist. For example, advertisements void of any history with a search engine do not have historical advertisement performance measures associated therewith. Additionally, advertisements that have had a limited number of impressions may have insufficient historical advertisement performance measures to generate accurate estimates. This can result in radically inaccurate estimated performance measures for the advertisements.

### BRIEF SUMMARY

Embodiments of the present invention relate to systems, methods, and computer-readable media for calculating charges for advertisements. The historical performance (such as CTR) of an on-line advertisement is utilized to calculate the current cost per selection or advertiser-desired user actions (click-through) for the advertisement. The current cost per advertiser-desired user action may be multiplied by the total number of advertiser-desired user actions to determine the adjusted revenue total for the advertisement. In embodiments, the charge for the advertisement is the adjusted revenue total for the advertisement less the amount of revenue previously received for the advertisement.

This Summary is provided to introduce a selection of concepts in a simplified that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a flow diagram illustrating methods for storing information for an advertisement;

FIG. 4 is a flow diagram illustrating a method for calculating charge due for an advertisement based on historical cumulative revenue in accordance with an embodiment of the present invention;

FIG. 5 is a table illustrating an example of calculating charge due for an advertisement in accordance with an embodiment of the present invention;

FIG. 6 is a graphical representation of an exemplary historical click-through rate in accordance with an embodiment of the present invention;

FIG. 7 is a graphical representation of a comparison of total revenue utilizing a historical click-through rate versus utilizing an estimated click-through rate for an advertisement in accordance with an embodiment of the present invention; and

FIG. 8 is a graphical representation of total revenue per day comparison in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems, methods, and computer-readable media for calculating charges for advertisements. In one aspect, a computer-implemented method for calculating a charge due for an advertisement is provided. The performance of an advertisement is utilized to calculate the current cost per advertiser-desired user action for the advertisement. The performance is the number of advertiser desired user actions per the number of times the advertisement was presented to one or more users. The current cost per selection and the total number of times the advertisement was presented are utilized to determine the adjusted charge for the advertisement. The charge due for the advertisement is determined by subtracting an amount of revenue previously received for the advertisement from the adjusted revenue total for the advertisement. The charge for the advertisement is presented.

In another aspect, a computerized system for calculating charge due for an on-line advertisement is provided. The system comprises a cost calculating component configured to calculate the current cost per advertiser desired user actions of an advertisement utilizing the performance of an advertisement, the performance being the number of advertiser desired user actions for the advertisement divided by the number of times the advertisement was presented to one or more users. The system also comprises an adjusted total calculation component configured to determine the adjusted revenue total for the advertisement by multiplying the current cost per selection and the total number of times advertiser desired user actions. The system further comprises a charge calculating component configured to determine the amount of charge for the advertisement by subtracting an amount of revenue previously received for the advertisement from the adjusted revenue total for the advertisement.

In yet another aspect, one or more computer readable media having computer-executable instructions embodied thereon that, when executed perform a method for calculating revenue due for an advertisement are provided. The method comprises utilizing a click-through rate (CTR) for an online advertisement to calculate the current cost per click-through of the advertisement. The click-through rate is the number of click-throughs of the advertisement divided by the number of times the advertisement was presented to one or more users. The current cost per click-through is compared to a bid for the advertisement to determine whether the cost per click-through exceeds the bid for the advertisement. If the cost per click through exceeds the bid for the advertisement, the charge is adjusted or the advertisement is suppressed. If the cost per click-through does not exceed the bid for the advertisement, he current cost per click-through is multiplied by the total number of times the advertisement was presented to determine the adjusted revenue total for the advertisement. The charge for the advertisement is determined by subtracting an amount of revenue previously received for the advertisement from the adjusted revenue total for the advertisement. The charge for the advertisement is stored in a data store.

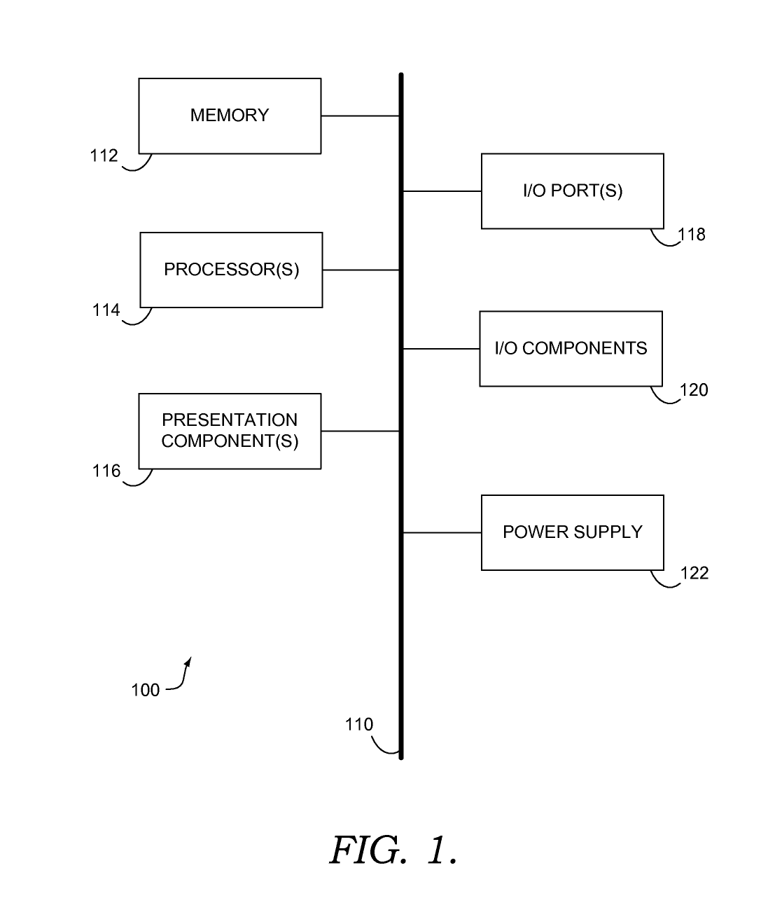

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/modules illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, etc. I/O ports 118 allow computing device 100 to be logically coupled to other devices including I/O modules 120, some of which may be built in. Illustrative modules include a microphone, joystick, game pad, satellite dish, scanner, printer, wireless device, etc.

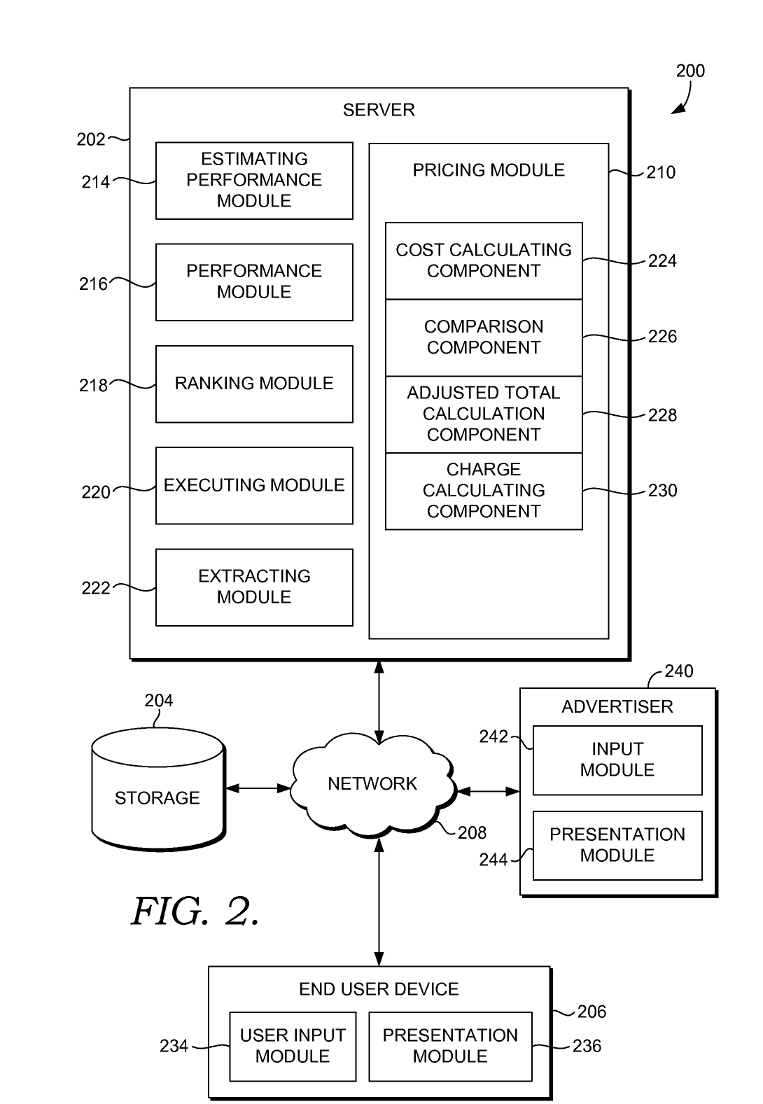

As previously set forth, embodiments of the present invention relate to computing systems for calculating charges for an auctioned service. With reference to FIG. 2, a block diagram is illustrated that shows an exemplary computing system architecture 200 configured for calculating charges for an auctioned service, in accordance with an embodiment of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components.

Computing system architecture 200 includes a server 202, a storage device 204, and an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with an advertisement. In various embodiments, such information may include, without limitation, bids, estimated performance of the advertisement, historical performance of the advertisement, impression totals, historical clicks or actions for the advertisement and charges or revenue paid for one or more advertisements. It will be appreciated that the modules and components discussed below access the storage device 204 to obtain the information needed to make determinations and calculations to determine the revenue due for an advertisement. In embodiments, the storage device 204 is configured to be searchable for one or more of the items stored in association therewith. It will be appreciated by those of ordinary skill in the art that the information stored in the storage device 204 may be configurable and may include a variety of information relevant to the advertisement. Further, though illustrated as a single, independent component, the storage device 204 may, in fact, be a plurality of storage devices, for instance a database cluster, portions of which may reside on the server 202, the end user device 206, another external computing device (not shown), and/or any combination thereof.

Each of the server 202 and the end-user device 206 shown in FIG. 2 may be any type of computing device, such as, for example, computing device 100 described above with reference to FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any a variety of different types of computing devices within the scope of embodiments thereof.

As shown in FIG. 2, the server 202 includes a pricing module 210, a performance estimating module 214, a historical performance module 216, a ranking module 218, an executing module 220 and an extracting module 222. In some embodiments, one or more of the illustrated modules may be implemented as stand-alone applications. In other embodiments, one or more of the illustrated modules may be integrated directly into the operating system of the server 202 and/or end user device 206. It will be understood by one of ordinary skill in the art that the modules illustrated in FIG. 2 are exemplary in nature and in number and should not be construed as limiting. Any number of modules may be employed to achieve the desired functionality within the scope of embodiments hereof. Further, modules may be located on any number of servers or computers. By way of example only, pricing module 210 may reside on a separate server or computer.

The performance estimating module 214 is configured to estimate the expected performance of an advertisement. Advertisement performance may include, by way of example only and not limitation, the number of user selections of an advertisement. User selections may include selections of a displayed advertisement including, click-throughs or performance of another action with respect to the displayed advertisement (e.g., purchasing a product or services, signing up for a newsletter, and the like). The advertisement for which an expected performance is estimated may be a new advertisement or an existing advertisement with limited historical data. Accordingly, performance estimating module 214 may be configured to estimate the initial expected performance for a new advertisement or an updated expected performance for an existing advertisement. To estimate an expected advertisement performance, the estimating module utilizes an advertisement performance prediction model, e.g., using estimated historical click-through rate (CTR) for that advertiser or for similar type advertisements. One skilled in the art will recognize that performance estimating module 214 may estimate advertisement performance in a variety of ways. The estimated expected advertisement performance may be stored in a storage device, such as storage device 204.

A performance module 216 is configured for calculating the performance of an advertisement, e.g. determining the CTR or action rate for an advertisement. It will be appreciated that the performance may be the historical performance of an advertisement, such as the historical CTR or action rate for an advertisement. The (CTRhist) for the advertisement may be determined as:

CTRₕᵢₛₜ=CₜₒₜₐₗIₜₒₜₐₗ

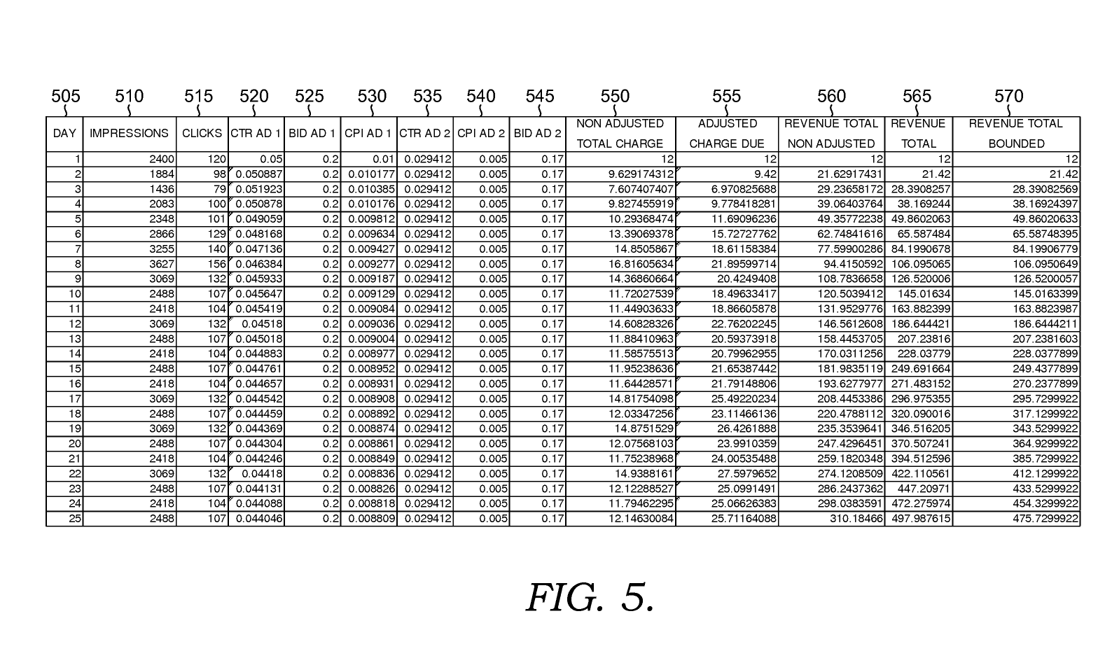

In the above equation, Cₜₒₜₐₗ is the total number of historical clicks on the advertisement and Iₜₒₜₐₗ is the number of impressions (e.g., times the advertisement has been displayed to users). The number of impressions can be further adjusted based on display context and location of the advertisement. For example, with reference to FIG. 5, for days 1 and 2, Advertisement A was displayed 4284 times and received 218 click-throughs. Thus, the historical performance rate or CTR of advertisement A is 0.050887. The historical performance may be updated for an advertisement each time a click-through or click-action occurs, or as shown in FIG. 5, on a periodic basis (such as hourly, daily, weekly or monthly).

It will be appreciated the historical action rate (Aₕᵢₛₜ) for an advertisement may be determined as:

Aₕᵢₛₜ=Aₜₒₜₐₗ/Iₜₒₜₐₗ

In the above equation, Atotal is the total number of actions (e.g., signing up for newsletter, purchasing product) for the advertisement and Itotal is the number of impressions (e.g., times the advertisement has been displayed to users).

The ranking module 218 is configured to determine advertisement rankings and adjust advertisement rankings if necessary. The advertisement ranking for each advertisement is determined based on the respective estimated expected performance measure determined (determined by estimating module 214) or, if available, the historical performance of the advertisement (determined by the historical performance module 216), or estimated advertisement revenue (which in turn uses performance estimates). Advertisements are presented (e.g., displayed) according to the advertisement ranking. Typically, the advertisement having the highest ranking will be awarded the most prominent display position, e.g., the top link of a vertical listing of links on a search engine web page that is displayed as the result of a particular user query. Upon selection of an advertisement by a user, the user may be redirected to a uniform resource locator (URL) (e.g., landing page, advertiser's webpage). The advertisement rankings determined utilizing the ranking module 218 may be stored in a storage device, such as storage device 204.

By way of example, and not by limitation, in revenue maximizing ranking auction, such as a second price auction, the ranking of three (3) new advertisements bidding for the same advertising display spot (e.g., same search terms) is determined by determining the externality the advertisement imposes on the other bidding advertisement. The estimating module 214 determines the estimated CTR for each advertisement. For example, if:

Advertisement A has a monetary bid of $1 and an estimated CTR of 1%
Advertisement B has a monetary bid of $0.50 and an estimated CTR of 1.5%
Advertisement C has a monetary bid of $0.30 and an estimated CTR of 1.1%

Then the advertisements would be ranked as:

1) Advertisement A with monetary value per click of $0.01
2) Advertisement B with monetary value per click of $0.0075
3) Advertisement C with a monetary value per click of $0.0033

It will be appreciated as historical data is collected, for example with respect to CTR, that the ranking module 218 will update the rankings. For example, if enough data has been collected for the historical performance module to calculate a historical CTR for advertisement A, the ranking of the advertisements is updated to reflect the historical CTR of advertisement A:

Advertisement A has a monetary bid of $1 and a historical CTR of 0.5%
Advertisement B has a monetary bid of $0.50 and an estimated CTR of 1.5%
Advertisement C has a monetary bid of $0.30 and an estimated CTR of 1.1%

Then the advertisements would be ranked as:

1) Advertisement B with a monetary value per click of $0.0075
2) Advertisement A with a monetary value per click of $0.005
3) Advertisement C with a monetary value per click of $0.0033

The executing module 220 is configured to implement the advertisement rankings. For example, the executing module will communicate with the presentation module 236 of an end user device 206 to present advertisements in order of advertisement ranking.

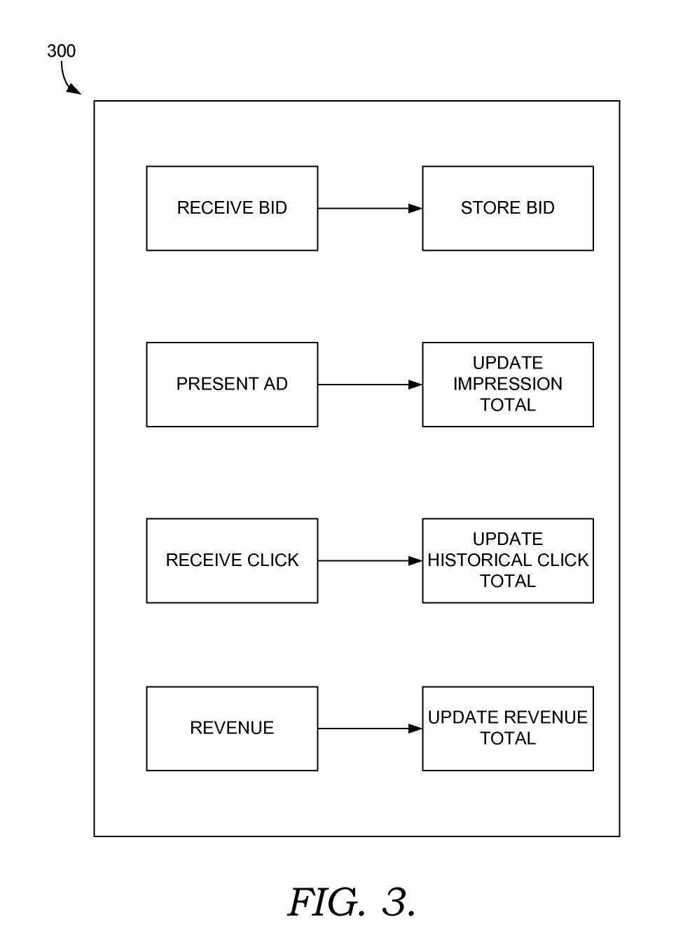

The extracting module 222 is configured to extract advertisement features. An advertisement feature may be a value or datum that represents advertisement information such as the number of clicks on the advertisement, number of actions based on the advertisement, number of impressions of the advertisement, and bids, revenue for the advertisement. For example, with reference to FIG. 3, the extracting module 222 is configured to extract bids, clicks or actions, impressions and revenue for an advertisement. The extracted information or data is stored and/or utilized to update totals, such as impression totals for the advertisement, historical clicks or actions for the advertisements and total revenue for the advertisement. This information may be utilized by the pricing module 210, discussed in detail below, to determine the appropriate revenue due for an advertisement.

The pricing module 210 is configured to determine the charge for an advertisement. The pricing module 210 illustrated in FIG. 2 includes a cost calculating component 224, a comparison component 226, an adjusted total calculation component 228 and a charge calculating component 230. In some embodiments, one or more of the illustrated components may be implemented as stand-alone applications. In other embodiments, one or more of the illustrated components may be integrated directly into the operating system of the server 202. It will be understood by those of ordinary skill in the art that the components illustrated in FIG. 2 are exemplary in nature and number and should not be construed as limiting. Any number of components may be employed to achieve the desired functionality within the scope of embodiments hereof.

The cost calculating component 224 calculates the cost per performance of an advertisement. In some embodiments, a pay per performance model is utilized. An exemplary pay per performance model is used in search engines, advertising networks, content websites/blogs, etc. Advertisers bid on keywords they believe their target market would type in the search bar when they are looking for a product or service. When a user types a keyword query matching the advertiser's keyword, the pay per performance model the cost calculating component may utilize a second price auction such as a Vickrey-Clark-Groves auction or a generalized second price auction or a variation thereof. In one embodiment, a second price auction is utilized for determining the cost per performance of an advertisement. It will be appreciated that the performance of an advertisement may be advertiser desired actions such as click-throughs or actions based on the advertisement.

By way of example, if the cost per performance is based on the click-throughs of an advertisement, the cost per performance is calculated by a second price auction (VCG) as:

Cost per performance=Bid_{below}*(CTR_{below}/CTRₕᵢₛₜ)

In the above equation, Bidbelow is the monetary bid of the advertisement ranked directly below Advertisement 1, CTRhist is the historical CTR of Advertisement 1 and CTRbelow is the CTR of the advertisement ranked directly below Advertisement 1. By way of example, with reference to FIG. 5, the cost per performance of Advertisement 1 through Day 2, which is ranked above Advertisement 2 by ranking module, would be

0.17*[0.029412/0.050887]=0.098277

The bid for the advertisement ranked below Advertisement 1 is 0.17. The CTR of the advertisement ranked below Advertisement 1 is 0.029412. The historical CTR of Advertisement 1 is 0.050887. As such, the cost per performance of Advertisement 1 for days 1 and 2 is 0.098277.

While the above example utilizes a second price auction to calculate the cost per performance, it will be appreciated that a variety of pay per performance models may be utilized to determine the cost per performance of an advertisement.

The comparison component 226 compares the cost per performance of an advertisement to the monetary bid for the advertisement to determine if the cost per performance calculated exceeds the monetary bid for the advertisement. For example, if the cost per performance of Advertisement 1 for days 1 and 2 is 0.098277 and the bid for advertisement is 0.2, the comparison component will determine that the cost per performance of the advertisement does not exceed the bid for the advertisement. If the cost per performance exceeds the bid for the advertisement, the bid amount for the advertisement is used to calculate the charge, rather than the cost per performance.

The adjusted revenue calculating component 228 calculates the total adjusted revenue for the advertisement. For example, the total adjusted revenue is the cost per performance calculated by the cost calculating component 224 multiplied times the total number of clicks or actions for the advertisement. By way of example, if the cost per performance is based on the CTR rate of an advertisement, the total adjusted revenue due for the advertisement is:

total adjusted revenue=current cost per performance*total click-throughs

By way of example, with reference to FIG. 5, for days 1 and 2, the total adjusted revenue for advertisement 1 is:

0.098277*218=$21.42

The cost per performance for Advertisement 1 for days 1 and 2 is 0.098277. The total number of click-throughs for Advertisement 1 for days 1 and 2 is 218. As such, the total revenue for Advertisement 1 for days 1 and 2 is $21.42.

The revenue calculating component 230 calculates the charge for the advertisement. For example, the charge due for the ad is the total adjusted revenue due for the advertisement less the total revenue already paid for the advertisement. As such, the revenue due for the advertisement may be calculated as:

Total Revenue due for Advertisement−Revenue Paid for Advertisement

By way of example, referring again to FIG. 5, for day 2, the total revenue due for Advertisement 1 is:

$21.42−$12.00=$9.42

Total revenue due for Advertisement 1 for days 1 and 2 is $21.42. The revenue already paid for Advertisement 1 through day 1 was $12.00. As such, the revenue due for the advertisement is $9.42.

As shown in FIG. 2, the end-user device 206 includes a user input module 234 and a presentation module 236. In some embodiments, one or more of the modules 234 and 236 may be implemented as stand-alone applications. In other embodiments, one or more both of the modules 234 and 236 may be integrated directly into the operating system of the end-user device 206. It will be understood by those of ordinary skill in the art that the modules 234 and 236 illustrated in FIG. 2 are exemplary in nature and in number and should be construed as limiting. Any number of modules may be employed to achieve the desired functionality within the scope of embodiments described herein.

The user input module 206 is configured for receiving input of search query terms. Typically, search query terms are input via a user interface (not shown) associated with the end-user device, or the like. Upon receiving input of search query terms, the presentation module 236 of end-user device 206 is configured for presenting advertisements to a user in order by rank number. The input module 206 may also be configured to receive selections or click-throughs of an on-line advertisement or actions based of the advertisement (e.g., purchasing a product). In one embodiment, the presentation module 236 presents a plurality of relevant advertisements utilizing a display device associated with the end-user device.

As shown in FIG. 2, the advertiser device 240 includes an input module 242 and a presentation module 244. In some embodiments, one or more of the modules 242 and 244 may be implemented as stand-alone applications. In other embodiments, one or more both of the modules 242 and 244 may be integrated directly into the operating system of the advertiser device 240. It will be understood by those of ordinary skill in the art that the modules 242 and 244 illustrated in FIG. 2 are exemplary in nature and in number and should be construed as limiting. Any number of modules may be employed to achieve the desired functionality within the scope of embodiments described herein.

The input module 242 is configured for receiving input of bids, estimated performance or CTR of advertisements, and the actual advertisements from an advertiser or agent of an advertiser. In one embodiment, this information is input via an advertiser interface (not shown) associated with the advertiser device, or the like. Upon receiving input of the information, the presentation module 244 presents the revenue due for an advertisement to an advertiser. The presentation module 244 may also present information such as the total revenue paid, the total impressions and click-throughs of an advertisement. In one embodiment, the presentation module 244 presents the charge on a display associated with the advertiser device.

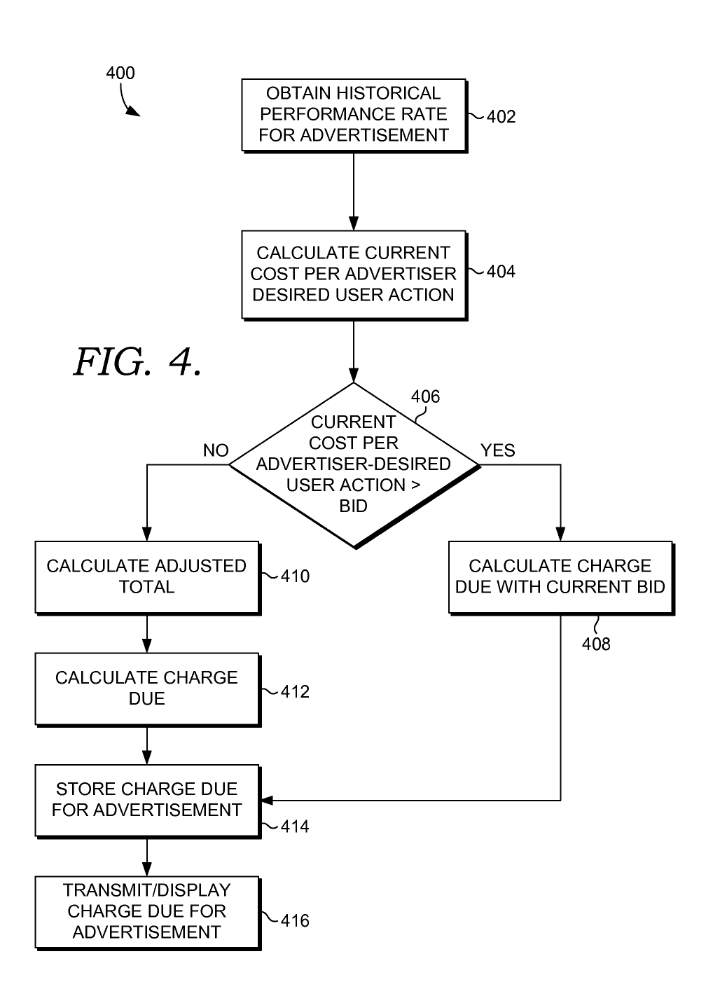

Referring next to FIG. 4, a method 400 for determining the charge for an advertisement is provided. At step 402, the historical performance rate for an advertisement is accessed. The historical performance rate may be the CTR or click-action rate for the advertisement. The historical performance rate may be accessed from a storage device or may be calculated or transmitted by the system. At step 404, the current cost for performance is calculated. The cost per performance is amount the advertiser pays for a performance of the advertisement (e.g., each time the advertisement receives a click-through or an action (e.g., signing up for a newsletter or making a purchase). The cost per performance of an advertisement may be calculated utilizing a second price auction, or variation thereof. For example, the second price auction may be a Vickrey-Clark Groves auction, a generalized second price auction or a variation thereof.

At step 406, the cost per performance calculated for an advertisement is compared to the bid placed by the advertiser. For example, in a second price auction, it is determined whether the cost per performance of the advertisement determined by a second price auction does not exceed the amount bid by the advertiser. The bid is the amount the advertiser is willing to pay for performance of the advertisement (e.g., a click-through or action). At step 406, if it is determined that the cost per performance of the advertisement exceeds the amount bid by the advertiser, the charge due for the advertisement is calculated using the current bid. For example, if the bid for each click-through for an advertisement was 0.075 and the cost calculated by a second price auction for each click-through of the advertisement was 0.080, then the advertiser is charged only the amount bid (0.075) for each click-through of the advertisement or the advertisement could be suppressed due to insufficiently high bid.

If at step 406 it is determined that the cost per performance calculated does not exceed the amount bid by the advertiser, at step 412 the total adjusted revenue for the advertisement is determined. The total adjusted revenue due for the advertisement is the cost per performance of the advertisement multiplied by the total number of performances (e.g., number of click-throughs or actions). At step 412, the charge due for the advertisement is determined. The charge for the advertisement is the total adjusted revenue due less the total revenue already paid for the advertisement. At step 414, the charge for the advertisement is stored. The total adjusted revenue for the advertisement may also be stored. The revenue due and total adjusted revenue for the advertisement may be stored in storage device 204 of FIG. 2.

At step 416, the charge for the advertisement may be transmitted, presented, communicated and/or displayed to the advertiser. The charge may be presented on a display associated with an advertiser's device.

Referring next to FIG. 5, table 500 illustrates an example of calculating one or more charges for an advertisement in accordance with an embodiment of the present invention. The data on the table includes the time frame 505 for the data for the advertisement. In the exemplary table 500, the data is per day. It will be appreciated that the time frame may be any each time a click-through or click action occurs, on a periodic basis (such as hourly, daily, weekly or monthly), or after a certain number of impressions, click-throughs or click-actions.

The data also includes the number of impressions 510 of the advertisement. The number of impressions includes the number of times the advertisement is presented to user(s). In this example, the advertisement for calculating revenue due is Advertisement 1. The data includes the number of clicks 515 (e.g., click-throughs or click-actions) for the time frame. The historical performance 520 (e.g., the click-through rate or click-action rate) of the advertisement and the bid 525 for the advertisement are included. The cost per impression 530 of the advertisement is also included.

The data also includes information for a second advertisement ranked beneath the first advertisement. For instance, Advertisement 2 may be ranked directly below Advertisement 1 by the ranking module 218 of FIG. 2. The data includes for the second advertisement includes the performance rate 535 (e.g., actual or estimated CTR or click-action rate) and the cost per impression of Advertisement 2. It will be appreciated, that while in FIG. 5, the performance rate for Advertisement 2 remains the same, that the performance rate for Advertisement 2 (or any other lower or higher ranked advertisement) may also change during particular time frames. The data also includes the bid for advertisement. The data for Advertisement 2 may be used in a second price auction or the like to determine the cost per performance for the higher ranked advertisement, in this case Advertisement 1.

The table also includes the adjusted revenue total 565 for Advertisement 1 (Cost per click-through*total clicks on advertisement) that has been calculated using the system and method described above. The table includes the non-adjusted charge 550 and the adjusted charge 555. The adjusted charge is calculated utilizing the system and method described above for the specified time period. For example the adjusted charge for day 2 is $9.42 (Adjusted Total Revenue−Revenue already received for Advertisement), while the non-adjusted charge for day 2 was $9.63 (cost per click-through*number of clicks on day 2). The table also includes what the non-adjusted revenue total 560 and is merely the sum of the non-adjusted charge 550 for that time period and preceding time periods (e.g., the non adjusted total revenue on day 2 is the sum of the non-adjusted charge for day 1 ($12.00) and day 2 ($9.63)). The data also includes the revenue total bounded by the advertiser bid 570. In the cases where the cost per impression exceeds the advertiser bid, the cost is capped by the bid.

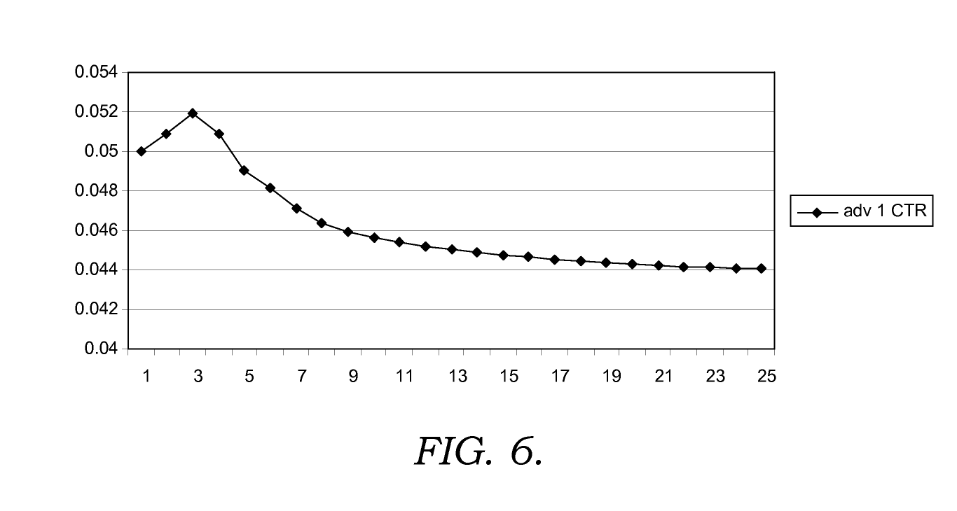

With reference to FIG. 6, a graphical representation of exemplary historical performance of an advertisement is shown. The graphical representation includes the CTR rate for Advertisement 1 of FIG. 5. From the graphical representation, it can be noted that it 1 performance and future performance prediction of the advertisement becomes more accurate (increases in confidence) with each display of the advertisement.

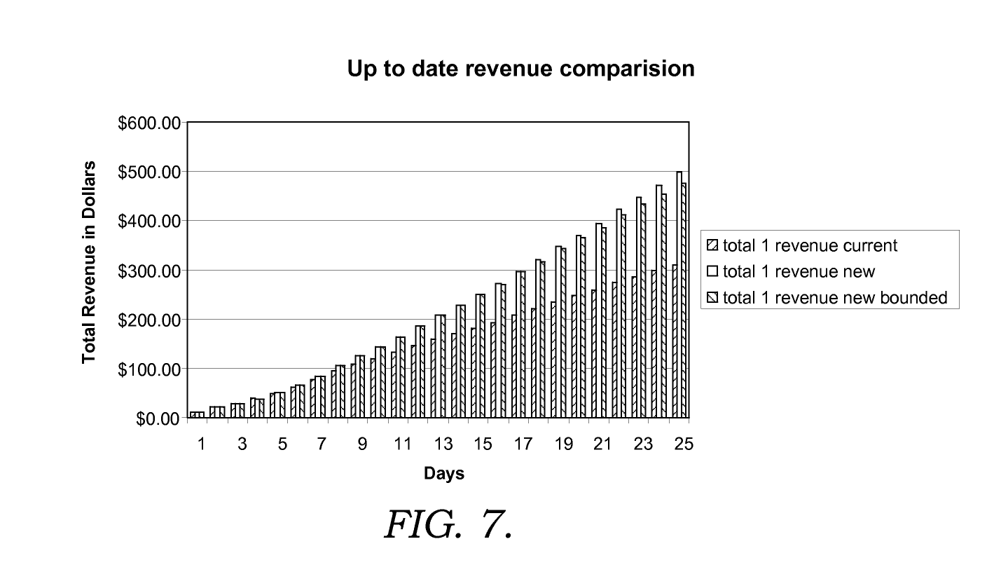

With reference to FIG. 7, a graphical representation of the comparison of total revenue due utilizing the revenue maximizing method of embodiments of the present invention versus computations without utilizing the revenue maximizing method of embodiments of the present invention. In particular, the total 1 cost current, merely takes into account the cost for performance for a particular time period represent the revenue total non-adjusted total revenue 560 of FIG. 5 and does not factor in previously paid revenue while the total 1 charge new represents the adjusted revenue total 565 if FIG. 5 that factors in previously paid revenue as described above. The adjusted total revenue calculated utilizing the system and method described in FIG. 2 and FIG. 4 exceeds that of merely adding daily revenues (e.g., the non-adjusted total revenue).

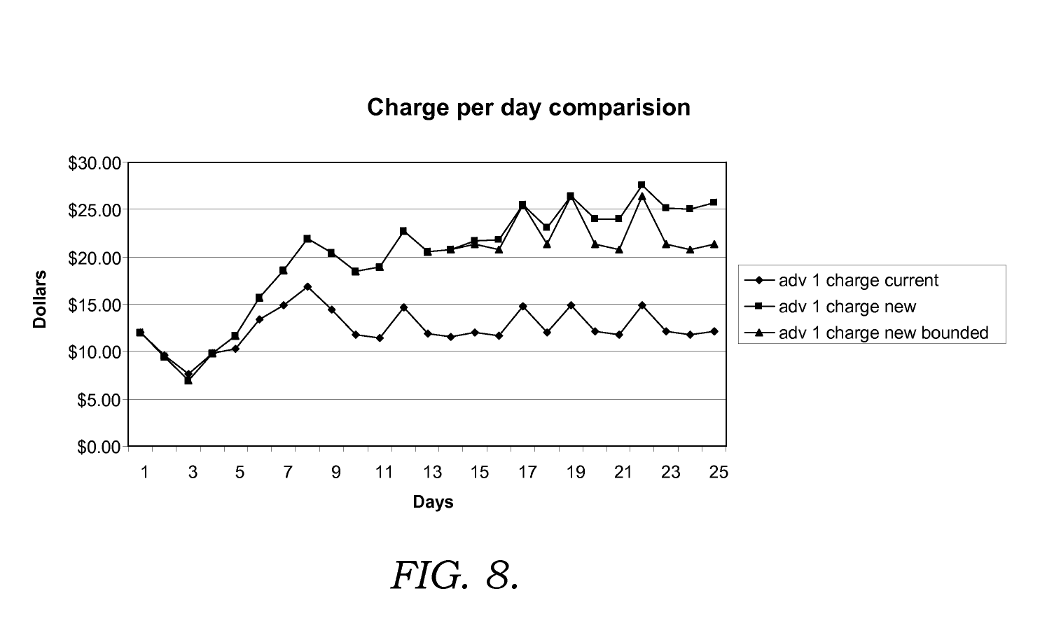

With reference to FIG. 8, a graphical representation of the total revenue day comparison is shown. FIG. 8 plots the daily adjusted revenue due 555 and non adjusted revenue due 550 from FIG. 5.

As described herein above, embodiments of the present invention provide systems, methods, and computer-readable media for calculating charge for advertisements. The performance (such as CTR) of an online advertisement is utilized to calculate the current cost per advertiser desired user action (click-through) of the advertisement. The current cost per advertiser desired user action may be multiplied by the total number of advertiser desired user actions to determine the adjusted revenue total for the advertisement. In embodiments, the charge for the advertisement is the adjusted revenue total for the advertisement less the amount of revenue previously received for the advertisement.

While the embodiments described above relate to calculating charges for on-line advertisements, it will be appreciated that the concepts are applicable to a variety of auctioned services, including, telemarketing, such as pay-per-call. In this embodiment, the “selection” is when a telemarketer calls customers/potential customers and sells a product or service, or develops a lead. The performance would be the total number of leads and/or sales divided by the total number of calls made to customers/potential customers.

Embodiments described herein are intended in all respects to be illustrative rather than restrictive. Alternative embodiments will become apparent to those of ordinary skill in the art without departing from the scope of embodiments described herein.

From the foregoing, it will be seen that embodiments of the present invention are well adapted to attain ends and objects set forth above, together with other advantages which are obvious and inherent to the systems and methods described. It will be understood that certain features and sub-combinations are of utility and may be employed without reference to other features and sub-combinations. This is contemplated by and is within the scope of the claims.

What is claimed is:

1. A computer-implemented method for calculating a charge for an advertisement, the method comprising:
utilizing performance of an advertisement to calculate the current cost per advertiser-desired user action for the advertisement, the performance being the number of advertiser-desired user actions per number of times the advertisement was presented to one or more users;
utilizing the current cost per advertiser-desired user action and the total number of times the advertisement was presented to determine the adjusted revenue for the advertisement; and
determining the charge for the advertisement by subtracting an amount of revenue previously received for the advertisement from the adjusted revenue total for the advertisement.

2. The method of claim 1, further comprising:
obtaining the performance for the advertisement.

3. The method of claim 1, further comprising
comparing the current cost per selection to a bid for the advertisement to determine whether the cost per advertiser-desired user action exceeds the bid for the advertisement, wherein if the cost per advertiser-desired user action exceeds the bid, the charge for the advertisement is capped at the bid or the advertisement is suppressed.

4. The method of claim 1, wherein the advertisement is an on-line advertisement.

5. The method of claim 1, wherein the advertiser-desired user actions are click-throughs, click-actions or a combination thereof.

6. The method of claim 1, wherein the advertiser-desired user actions are conversions.

7. The method of claim 1, wherein the performance is the historical click-through rate (CTR) for the advertisement or the historical conversion rate for an advertisement.

8. The method of claim 1, further comprising:
presenting the charge for the advertisement.

9. A computerized system for calculating a charge for an on-line advertisement, the system comprising:
a cost calculating component configured to calculate the current cost per selection of an advertisement utilizing the performance of an advertisement, the performance being the number of advertiser-desired user actions per the number of times the advertisement was presented to one or more users;
an adjusted total revenue calculation component configured to determine the adjusted revenue total for the advertisement by multiplying the current cost per selection and the total number of times the advertisement was presented to one or more users; and
a charge calculating component configured to determine the charge for the advertisement by subtracting an amount of revenue previously received for the advertisement from the adjusted revenue total for the advertisement.

10. The system of claim 9, further comprising
comparing component configured to compare the current cost per advertiser-desired user action to a bid for the advertisement to determine whether the cost per advertiser-desired action exceeds the bid for the advertisement.

11. The system of claim 10, further comprising
an adjusting component configured to adjust the cost per advertiser-desired user action adjust the cost per advertiser-desired user action or suppress the advertisement if the cost per advertiser-desired user action exceeds the bid.

12. The system of claim 11, wherein the advertisement is an on-line advertisement.

13. The system of claim 12, wherein the advertiser-desired user actions are click-throughs.

14. The system of claim 12, wherein the advertiser-desired user actions are click-actions.

15. The system of claim 13, wherein the advertiser-desired actions are conversions, where a user action is taken as a customer for the advertiser.

16. The system of claim 15, wherein the performance is the historical click-through rate (CTR) for the advertisement or historical conversion rate.

17. The system of claim 15, further comprising a presentation component configured to present the charge due for the advertisement.

18. The system of claim 15, further comprising:
an input component configured to receive input of one or more bids for the advertisement.

19. The system of claim 10, wherein the performance is the historical action rate for the advertisement.

20. One or more computer readable media having computer-executable instructions embodied thereon that, when executed perform a method for calculating a charge due for an advertisement, the method comprising:
utilizing a click-through rate (CTR) for an online advertisement to calculate the current cost per click-through of the advertisement, the click-through rate being the number of click-throughs of the advertisement divided by the number of times the advertisement was presented to one or more users;
comparing the current cost per click-through to a bid for the advertisement to determine whether the cost per click-through exceeds the bid for the advertisement and adjusting the charge or suppressing the advertisement if the cost click-through exceeds the bid;
multiplying the current cost per click-through and the total number of times the advertisement was presented to determine the adjusted revenue total for the advertisement;
determining the charge due for the advertisement by subtracting an amount of revenue previously received for the advertisement from the adjusted revenue total for the advertisement; and
storing the charge due for the advertisement.
